(19) United States
(12) Patent Application Publication
(10) Pub. No.: US 2005/0197602 A1
(43) Pub. Date: Sep. 8, 2005

(54) Cushion mat with free rotational ball

(76) Inventor: Jeung Ui Kwen, Seoul (KR)

Correspondence Address: EDELL, SHAPIRO & FINNAN, LLC, 1901 RESEARCH BOULEVARD, SUITE 400, ROCKVILLE, MD, 20850, US

(21) Appl. No.: 10/791,770

(22) Filed: Mar. 4, 2004

(51) Int. Cl. A61H 15/00

(52) U.S. Cl. 601/131; 601/134; 601/136; 601/138

(57) ABSTRACT

Disclosed is cushion mat with a free rotational ball, the cushion mat including: a plurality of rotational ball units having a rotational ball for rotating whenever a person sitting on the cushion mat is in motion, and a housing for housing the rotational ball; and a connection string for passing through each of the plurality of rotational ball units in zigzags to unite and fix the plurality of rotational ball units.

### BACKGROUND OF THE INVENTION

1. Field of the Invention

The present invention relates to a cushion mat, and more particularly, to a cushion mat provided therein with a free rotation ball, which is made by uniting a plurality of rotation ball units constructed such that the free rotational ball is upwardly protruded.

2. Description of the Related Art

Generally, a long-time sitting seat, such as an office chair or a car seat, and a long-time sitting under-floor heating system use a cushion mat laid thereon.

As such, the cushion mat on which a person sits for a long time generally formed of a soft cushion or formed of a united bamboo and the like is mainly used.

However, the cushion mat using the soft cushion provides a soft comfort in case of a short-time sitting, but has a drawback in that in case of a long-time sitting, a ventilation is not performed thereby being easily in sweat and a blood circulation of a leg portion is not normally performed.

Also, the cushion mat using the united bamboo and the like provides good ventilation thereby not being in sweat, but has a drawback in that a user cannot be easily in motion thereby overstraining a user's body when the user gets off a driver seat or needs a little motion.

On the other hand, the seat and the cushion mat not performing its own performance causes a modern person to suffer from various chronic diseases such as a blood mass or a thrombus due to an absolutely much time spent in a sitting life.

### SUMMARY OF THE INVENTION

Accordingly, the present invention is directed to a cushion mat with a free rotational ball that substantially obviates one or more problems due to limitations and disadvantages of the related art.

An object of the present invention is to provide a cushion mat with a free rotation ball in which the free rotation ball is embedded to protrude upward such that a blood circulation of a human lower body can be helped and an effect of a finger pressure therapy can be not only obtained, but also a user's motion can be secured.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a cushion mat with a free rotational ball, the cushion mat including: a plurality of rotational ball units having a rotational ball for rotating whenever a person sitting on the cushion mat is in motion, and a housing for housing the rotational ball; and a connection string for passing through each of the plurality of rotational ball units in zigzags to unite and fix the plurality of rotational ball units.

It is characterized in that the rotational ball is formed of a material radiating a far infrared ray, and has a diameter of 10-30 mm.

Further, it is characterized in that the housing includes an upper housing having a circular through-hole formed at a center thereof to expose the rotational ball, and a lower housing for housing the rotational ball assembled to the upper housing within a certain space.

Furthermore, it is characterized in that the housing has a circular through-hole formed at an upper portion thereof to expose the rotational ball, and a ventilation through-hole formed at a lower portion thereof.

Additionally, it is characterized in that the housing has mutually contactable side surfaces rounded to form a gap space between the side surfaces so as to reduce a friction force when the plurality of rotational ball units is connected with one another.

Further, it is characterized in that the housing has a groove formed at a mutually contactable side surface so as to reduce a friction force when the plurality of rotational ball units is connected with one another.

In another aspect of the present invention, there is provided a cushion mat with a free rotational ball, the cushion mat including: a first wall body formed to have a rounded rectangular shape with a large height, a plurality of assembly recesses concaved at a lower side thereof, and a paired first connection through-hole and a paired second connection through-hole formed alternately and one by one on a mutual-adjacent side surface thereof; an upper housing comprised of a top portion being convexly extended from an upper side of the first wall body and having a circular rotational through-hole formed at a center thereof; a second wall body having a plurality of assembly protrusions protruded from an upper side thereof to be correspondingly combined to the assembly recesses; and a lower housing comprised of a bottom portion being perpendicularly extended from a lower side of the second wall body to close a lower portion and having a ventilation through-hole formed at a center thereof, wherein a plurality of rotational ball units is assembled including of the upper and lower housings and the rotational balls having the spherical-shapes, the rotational balls are housed within the upper and lower housings at the time of assembling the upper and lower housings to allow the rotational balls to rotate in a state in which its one portion is exposed through the rotation through-hole, and the plurality of rotational ball units is united and fixed by a connection string passing through each of the first connection through-hole and the second connection through-hole in zigzags.

Further, it is characterized in that the rotational ball is formed of a material radiating a far infrared ray.

Furthermore, it is characterized in that the rotational ball has a diameter of 10-30 mm, and the first and second wall bodies have four rounded side surfaces.

Additionally, the first and second wall bodies have grooves formed at four side surfaces thereof.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a disassembled rotational ball unit according to a preferred embodiment of the present invention;

FIG. 2 is a perspective view illustrating a bottom surface of an upper housing according to a preferred embodiment of the present invention;

FIGS. 3 and 4 are a perspective view and a perspective view with a part-cut portion illustrating an assembled rotational ball unit according to a preferred embodiment of the present invention;

FIG. 5 is a perspective view illustrating a cushion mat according to a preferred embodiment of the present invention;

FIG. 6 is a use state of a cushion mat according to a preferred embodiment of the present invention; and

FIGS. 7A and 7B are perspective views of assembled rotational ball units according to other embodiments of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

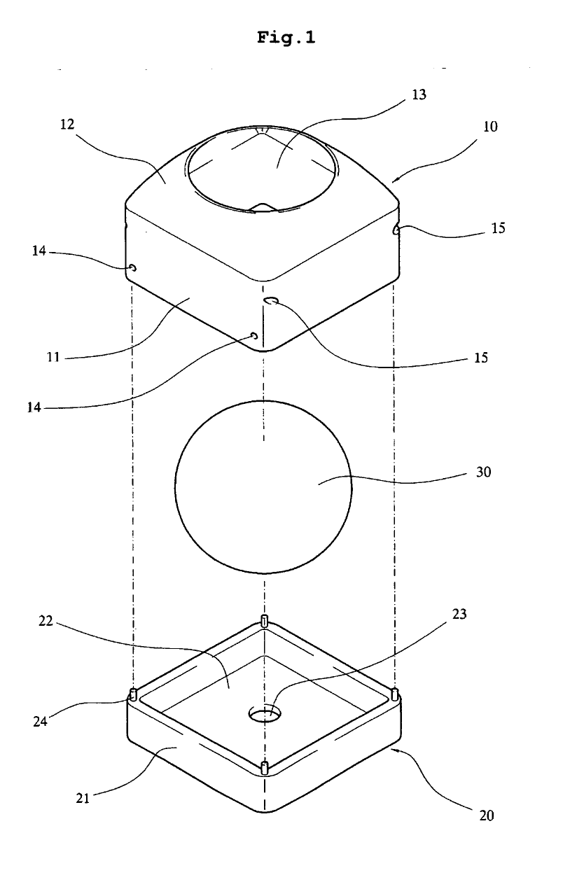

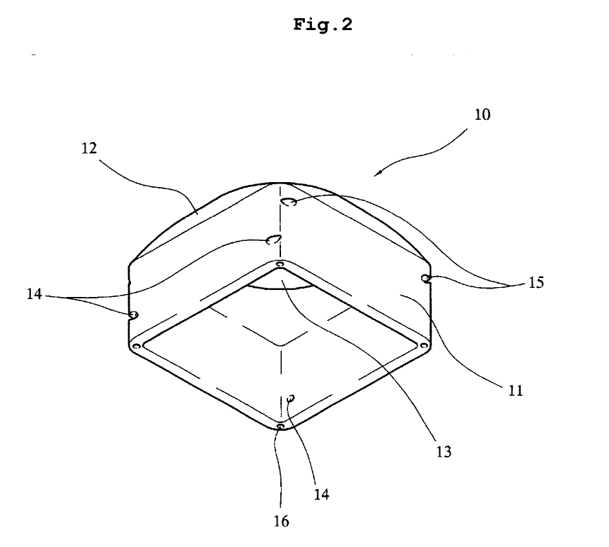

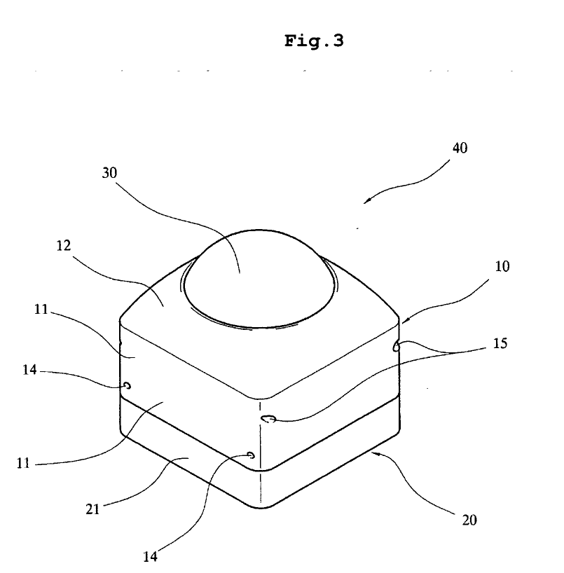

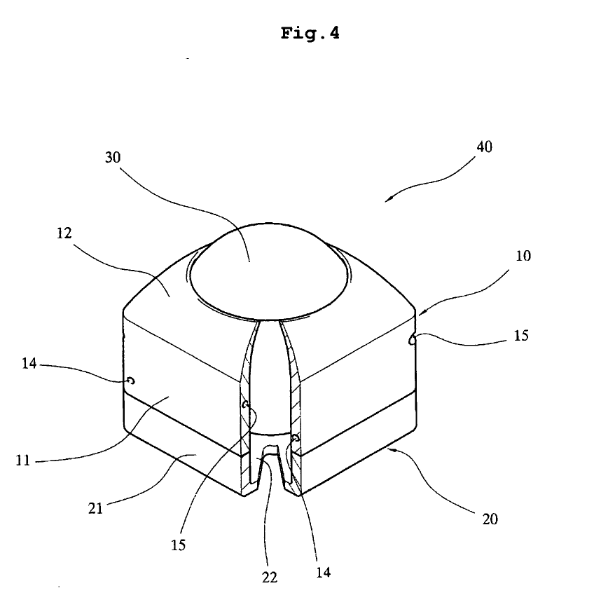

FIG. 1 is a perspective view illustrating a disassembled rotational ball unit according to a preferred embodiment of the present invention, FIG. 2 is a perspective view illustrating a bottom surface of an upper housing according to a preferred embodiment of the present invention, FIGS. 3 and 4 are a perspective view and a perspective view with a part-cut portion illustrating an assembled rotational ball unit according to a preferred embodiment of the present invention.

As shown in the drawings, the inventive cushion mat includes a plurality of rotational ball units 40 having rotational balls 30 for rotating whenever a person sitting on the cushion mat is in motion, and housings 10 and 20 for housing the rotational ball; and a connection string for passing through each of the rotational ball units in zigzags to unite and fix the rotational ball units.

Further, the housings are comprised of an upper housing 10 having a circular rotation through-hole 13 formed at a center thereof such that the rotational ball 30 can be exposed; and a lower housing 20 for housing the rotational ball 30 combined to the upper housing 10 within a predetermined space.

Furthermore, the upper housing 10 includes a wall body 11 formed to have a rounded rectangular shape and a large height, and a top portion 12 convexly extended from an upper side of the wall body 11.

Herein, the wall body 11 has assembly recesses 16 upwardly concaved at respective corners of four lower surfaces thereof, and has a paired first connection through-hole 14 and a paired second connection through-hole 15 formed alternately and one by one on a mutual-adjacent side surface thereof. The connection through-holes of the same kind are in parallel formed on opposing surfaces.

Additionally, the top portion 12 has a circular rotation through-hole 13 formed at a center thereof.

Meanwhile, it is desirable that the upper housing 10 has an inner surface that is straight-shaped excepting for a curved portion so as to minimize a contact surface with the rotational ball 30.

Further, the lower housing 20 is comprised of a wall body 21 and a bottom portion 22.

Herein, the wall body 21 can be formed to have a height much less than the wall body 11 of the upper housing 10, and has a plurality of assembly protrusions 24 protruded upwardly to be correspondingly combined to the assembly recesses 16.

Further, the bottom portion 22 is perpendicularly extended from a lower side of the wall body 21 to an internal side to close a lower portion of the lower housing 20, and has a ventilation through-hole 23 formed at a center thereof.

Furthermore, the assembly recesses 16 provided on respective corners of four lower surfaces of the upper housing 10 and the assembly protrusions 24 provided on respective corners of four lower surfaces of the lower housing 20 are combined with each other such that the rotational ball 30 is rotatably housed within the combined housings.

Additionally, the rotational ball 30 is spherical-shaped, and is housed within the housings 10 and 20 when the upper housing 10 and the lower housing 20 are assembled such that the rotational ball 30 is freely rotated in a state in which one portion of the rotational ball 30 is exposed to an external through the rotation through-hole 13.

At this time, the rotational ball 30 is freely rotated in a point-contact state of the wall body 11 and the bottom portion 22 that are straight-shaped to minimize a friction force.

Of course, it is desirable that even the top portion 12 does not have a surface contact with the rotational ball 30 to the maximum.

Further, it is desirable that the rotational ball 30 has a diameter of 10 to 30 mm so as to maximize an effect of a finger pressure therapy.

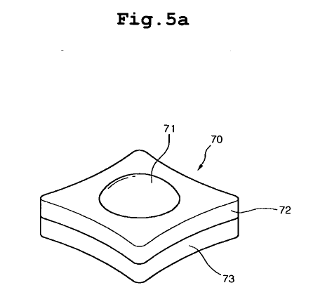

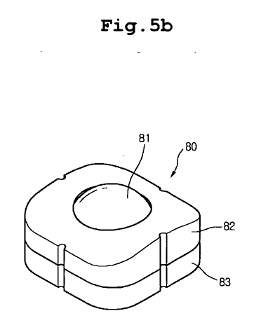

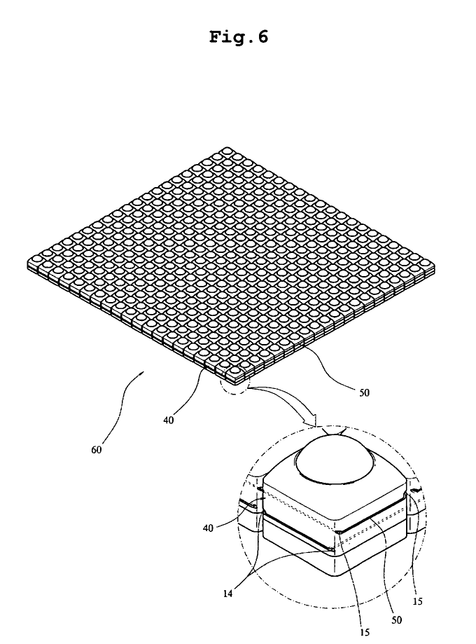

FIG. 5 is a perspective view illustrating the cushion mat according to a preferred embodiment of the present invention, and FIG. 6 is a use state of the cushion mat according to a preferred embodiment of the present invention.

As shown in FIG. 5, the assembled rotational ball unit 40 is provided in numbers and is united by the connection string 50 to form the cushion mat 60.

At this time, it is desirable that the connection string 50 passes through each of the first connection through-hole 14 and the second connection through-hole 15 in zigzags.

In the cushion mat 60 according to the present invention, since the rotational ball 30 exposed to the upper side through the rotational through-hole 13 is freely rotated, the rotational ball 30 rotates according to a user's motion while providing the finger pressure therapy to activate the blood circulation. Further, a direction conversion of a user's posture is easily accomplished within a narrow space such that a user's motion can be secured in flexibility.

Further, as shown in FIG. 6, if the cushion mat 60 is installed and used on a driver's seat of a car, a driver, especially a woman-driver wearing a skirt can slidingly get on and off the car. In addition, since the cushion mat 60 according to the present invention has a very good ventilation performance thereby preventing the driver from being in a sweat and always maintaining the driver to be in a good condition, various chronic diseases and the like that can be easily taken in a sitting life can be effectively prevented.

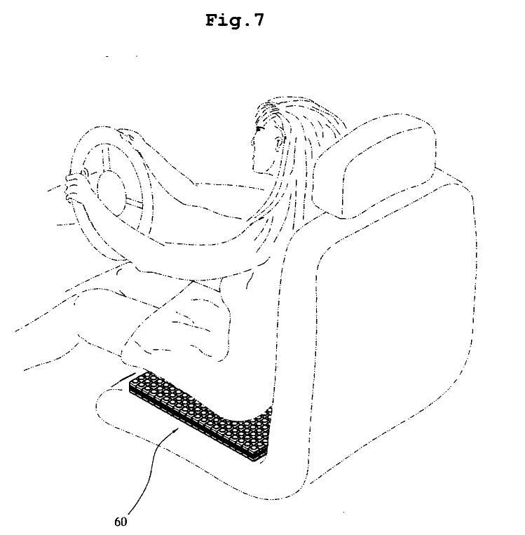

FIGS. 7A and 7B are perspective views of assembled rotational ball units according to other embodiments of the present invention.

As shown in FIGS. 7A and 7B, when the plurality of assembled rotational ball units are united by the connection string to form the cushion mat, the assembled rotational ball units can be constructed in various formats so as to minimize the friction between the plurality of assembled rotational ball units.

That is, as shown in FIG. 7A, the rotational ball unit 70 according to another embodiment of the present invention includes a rotational ball 71 for rotating according to the motion of the user sitting on the cushion mat; and upper and lower hexahedral housings 72 and 73 for housing the rotational ball 71 therebetween. When the hexahedral housing is rounded at four side surfaces thereof such that when the rotational ball units are united to form the cushion mat, a gap space between the rotational ball units can be secured thereby minimizing the friction between the plurality of rotational ball units.

In the meanwhile, it is desirable that the rotational ball 30 is formed of a material radiating a far infrared ray such as jade, elvan and germanium. In this case, a human blood circulation is more promoted by radiation of the far infrared ray to thereby more effectively recover a fatigue and prevent a chronic disease.

The present invention described above can be not only used for the cushion mat, but also can be used for a bed mattress, a bottom plate for the finger pressure therapy or the like.

As described above, the present invention has an effect in that the free rotational ball is embedded to upwardly protrude such that the blood circulation of the human lower body can be helped and the finger pressure therapy can be effected thereby reducing the fatigue and preventing the chronic diseases.

Further, the present invention has effects in that since the free rotational ball secures the user's motion, the user is not overstrained and the driver can easily and conveniently get on and off the car in case that the cushion mat is installed and used on the driver's seat.

It will be apparent to those skilled in the art that various modifications and variations can be made in the present invention. Thus, it is intended that the present invention covers the modifications and variations of this invention provided they come within the scope of the appended claims and their equivalents.

1. A cushion mat with a free rotational ball, the cushion mat comprising:
a plurality of rotational ball units each having a rotational ball for rotating whenever a person sitting on the cushion mat is in motion, and a housing for housing the rotational ball; and
a connection string for passing through each of the plurality of rotational ball units in zigzags to unite and fix the plurality of rotational ball units.

2. The cushion mat according to claim 1, wherein the rotational ball is formed of a material radiating a far infrared ray.

3. The cushion mat according to claim 1, wherein the rotational ball has a diameter of 10-30 mm.

4. The cushion mat according to claim 1, wherein the housing includes an upper housing having a circular through-hole formed at a center thereof to expose the rotational ball, and a lower housing for housing the rotational ball assembled to the upper housing within a certain space.

5. The cushion mat according to claim 1, wherein the housing has a circular through-hole formed at an upper portion thereof to expose the rotational ball, and a ventilation through-hole formed at a lower portion thereof.

6. The cushion mat according to claim 1, wherein the housing has mutually contactable side surfaces rounded to form a gap space between the side surfaces so as to reduce a friction force when the plurality of rotational ball units is connected with one another.

7. The cushion mat according to claim 1, wherein the housing has a groove formed at a mutually contactable side surface so as to reduce a friction force when the plurality of rotational ball units is connected with one another.

8. A cushion mat with a free rotational ball, the cushion mat comprising:
a first wall body formed to have a rounded rectangular shape with a large height, a plurality of assembly recesses concaved at a lower side thereof, and a paired first connection through-hole and a paired second connection through-hole formed alternately and one by one on a mutual-adjacent side surface thereof;
an upper housing comprised of a top portion being convexly extended from an upper side of the first wall body and having a circular rotational through-hole formed at a center thereof;
a second wall body having a plurality of assembly protrusions protruded from an upper side thereof to be correspondingly combined to the assembly recesses; and
a lower housing comprised of a bottom portion being perpendicularly extended from a lower side of the second wall body to close a lower portion and having a ventilation through-hole formed at a center thereof,
wherein a plurality of rotational ball units is assembled including of the upper and lower housings and the rotational balls having the spherical-shapes, the rotational balls are housed within the upper and lower housings at the time of assembling the upper and lower housings to allow the rotational balls to rotate in a state in which its one portion is exposed through the rotation through-hole, and the plurality of rotational ball units is united and fixed by a connection string passing through each of the first connection through-hole and the second connection through-hole in zigzags.

9. The cushion mat according to claim 8, wherein the rotational ball is formed of a material radiating a far infrared ray.

10. The cushion mat according to claim 8, wherein the rotational ball has a diameter of 10-30 mm.

11. The cushion mat according to claim 8, wherein the first and second wall bodies have four rounded side surfaces.

12. The cushion mat according to claim 8, wherein the first and second wall bodies have grooves formed at four side surfaces thereof.
